(19) United States
(12) Patent Application Publication
(10) Pub. No.: US 2025/0104052 A1
(43) Pub. Date: Mar. 27, 2025

(54) NOVEL GENERATIVE ARTIFICIAL INTELLIGENCE/LARGE LANGUAGE MODEL APPLICATION FOR COMPANIES/ENTITIES TO INTERACT WITH ANY APPLICATION THAT PROTECTS PERSONALLY IDENTIFIABLE INFORMATION/NONPUBLIC PRIVATE INFORMATION FOR ALL MONETARY AND INFORMATIONAL TRANSACTIONS [THE CATCHER]

(71) Applicants: Carlo Caravetta, Grand Saline, TX (US); Michael Korniczky, Las Vegas, NV (US)

(72) Inventors: Carlo Caravetta, Grand Saline, TX (US); Michael Korniczky, Las Vegas, NV (US)

(21) Appl. No.: 18/894,647

(22) Filed: Sep. 24, 2024

Related U.S. Application Data
(60) Provisional application No. 63/540,453, filed on Sep. 26, 2023.

(51) Int. Cl. G06Q 20/38; G06F 21/62; G06Q 20/40

(52) U.S. Cl. CPC G06Q 20/382; G06F 21/6254; G06Q 20/4014

(57) ABSTRACT

This disclosure provides a generative AI application designed to secure monetary and informational transactions by obfuscating Personally Identifiable Information (PII) and Nonpublic Personal Information (NPI). Users initiate transactions through Pitcher™, an application installed on their electronic devices, which generates a Generative Artificial Intelligence Number (GAIN™), replacing traditional PII during transactions. Companies or entities interacting with users employ the Catcher™ app to complete transactions while ensuring no PII retention by synchronizing with the Pitcher™ app. By removing PII after transactions, The Catcher™ minimizes the risk of data breaches, reduces company liability, and streamlines regulatory compliance.

### CROSS REFERENCE TO RELATED APPLICATIONS

This application claims the benefit of priority to U.S. Provisional Patent Application No. 63/540,453 filed on Sep. 26, 2023, which is incorporated herein by reference in its entirety.

### TECHNICAL FIELD

Aspects and implementations of the present disclosure relate to eCommerce, financial transactions, and the secure handling of Personally Identifiable Information (PII) and Nonpublic Personal Information (NPI). More specifically, this invention pertains to a cross-service transaction platform that utilizes generative artificial intelligence (AI) to secure confidential data and facilitate secure transactions without retaining sensitive personal information.

### BACKGROUND

### Problem

The increasing prevalence of data breaches and regulatory scrutiny regarding PII and NPI management burdens companies globally. Storing massive amounts of sensitive information increases their exposure to cyberattacks and legal liabilities. Regulatory fines and penalties for data breaches are becoming unsustainable, especially for smaller enterprises. Moreover, once individuals share their PII with third-party companies, they lose control over how their data is used.

### Existing Solutions

Current solutions often involve stricter regulations that impose higher costs for compliance but fail to fully address the risk of breaches. Conventional security measures rely heavily on companies securely managing and storing PII, but this centralized data storage model remains vulnerable.

### Need for a Novel Solution

There is a critical need for a solution that shifts the control of PII back to the individual and eliminates the burden on companies to store sensitive data. Such a solution should enable secure, real-time transactions without exposing companies to risks associated with PII retention.

### SUMMARY

The Catcher™ (Catcher is a trademark of Carlo Caravetta, Grand Saline, Texas) is a novel platform designed for companies and entities that securely handle monetary and informational transactions by interacting with a companion application, Pitcher™ (Pitcher is a trademark of Carlo Caravetta, Grand Saline, Texas), installed on users' devices. This invention eliminates the need for companies to store PII by utilizing the GAIN™ (GAIN is a trademark of Carlo Caravetta, Grand Saline, Texas), a unique identifier generated by the Pitcher© app for each user.

The Catcher™ app interfaces with a company's transaction system to facilitate secure transactions without accessing or retaining the user's PII. All personal data is stored locally on the user's device, and only the GAIN™ is transmitted during interactions with merchants. This model significantly reduces the risk of data breaches and eliminates liability for improper handling of PII.

The Catcher© ensures that companies comply with regulatory requirements without the need for storing PII. By integrating The Catcher© and Pitcher© apps, this solution ensures privacy and security in digital and in-person transactions.

### BRIEF DESCRIPTION OF THE DRAWINGS

FIG. 1 illustrates a system overview.

FIG. 2 illustrates the process of another aspect of the invention.

### DETAILED DESCRIPTION

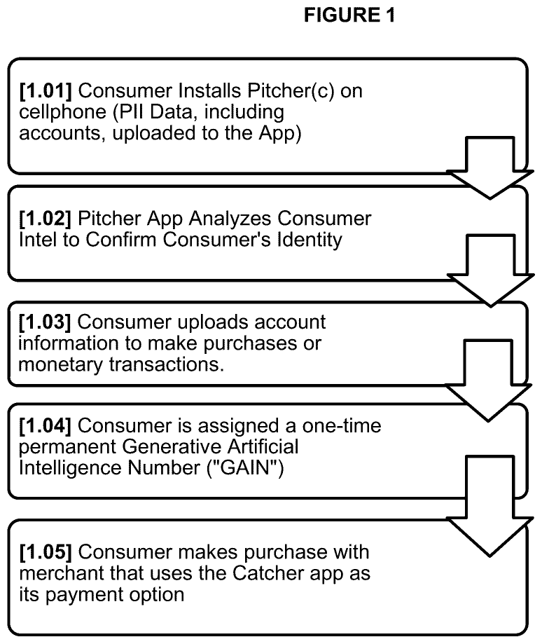

FIG. 1 illustrates a system overview.

User Application (Pitcher™): The Pitcher™ app is installed on the user's device. It acts as a personal vault for PII, including financial data such as credit card information, bank account details, and personal identifiers. Upon initiating a transaction, the user's identity is verified through an AI-driven process that analyzes device data and historical transaction patterns with the user's consent. Once verified, the user is assigned a unique GAIN™, which serves as a pseudonym for all transactions moving forward.

Company/Entity Application (The Catcher™): Merchants or service providers install the Catcher™ app, enabling them to receive transaction requests from users without accessing their PII. The Catcher© app synchronizes with the Pitcher™ app, using the GAIN™ for transaction purposes, which shields the user's PII from the merchant. Once the transaction is completed, the merchant's system removes all PII-related data, ensuring only the GAIN™ is retained for record-keeping purposes.

Transaction Process: Users interact with merchants by choosing the Catcher™ as their payment method. The GAIN™ generated by Pitcher™ is transmitted to the Catcher™, enabling the merchant to process payments and orders without direct access to the user's PII. Following the transaction, all user data is scrubbed from the merchant's system, and only the GAIN™ remains as a record of the transaction.

Security Mechanisms: The GAIN™ is tied to an advanced quantum encryption model that ensures its uniqueness and integrity. No PII is stored on company servers, and all user data is localized to their devices.

Data Removal and Regulatory Compliance: After the completion of each transaction, The Catcher™ ensures full deletion of any temporarily held PII from the merchant's systems. The system is designed to comply with global data protection regulations, reducing the costs and legal risks of handling sensitive information.

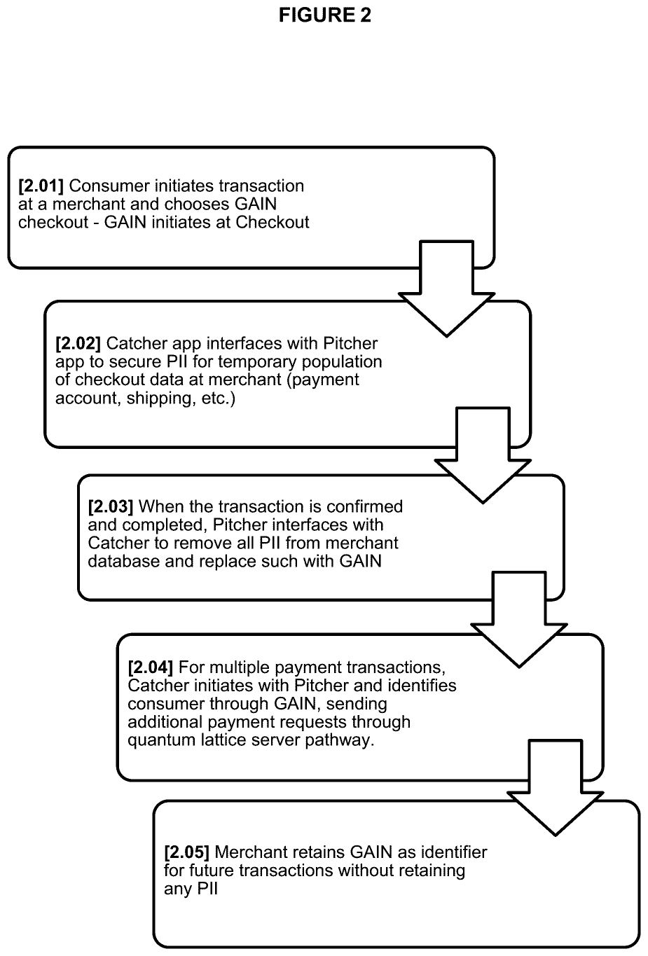

FIG. 2 illustrates the process of another aspect of the invention.

Pathway Through Quantum Computing Lattice Platform Established (No PII): Once the consumer is assigned a Generative Artificial Intelligence Number (GAIN™) via the Pitcher™ app, a permanent, encrypted pathway is established through a quantum computing lattice platform. This pathway serves as the identifier for the consumer, allowing them to make purchases, apply for loans, and initiate time-based payments without the need to share their Personally Identifiable Information (PII) directly. This ensures that even in the event of multiple transactions or interactions, the consumer's PII is never exposed to the merchant, platform, or waterfall system.

Customer Goes to Make Purchase at Merchant/Platform/Waterfall—Implements at Checkout: The transaction begins when the consumer initiates a purchase, whether at a physical merchant, online platform, or waterfall system, using the Pitcher™ app. At checkout, the consumer selects Pitcher™ as the payment method. The merchant's system, which has the Catcher™ app integrated via an API, automatically connects to the consumer's Pitcher™ app to process the transaction.

The Pitcher™ App Interfaces with Catcher™ App (in API of Merchant/Platform/Waterfall, etc.): Upon initiating the transaction, the Pitcher™ app securely interfaces with the Catcher™ app embedded within the merchant's system. During this process, the Pitcher™ app uploads consumer financial data, including necessary information to complete the transaction, such as credit determinations for loan or term payment approvals. At this stage, the merchant or platform has full access to the consumer's data needed to assess and approve/decline the transaction. This process includes generating shipping details, confirming purchase details, and populating other necessary data fields required to finalize the transaction.

Pitcher Removes All Consumer PII (PII Replaced With GAIN™ in Loan/Payment Transactions): Upon the transaction's completion, the Pitcher™ app, in conjunction with the Catcher™ app, operates to remove all PII associated with the consumer. If the transaction is declined, the consumer's PII is immediately deleted from both the Pitcher™ and Catcher™ systems, and no further identifiers, including the GAIN™, are retained. If the transaction is approved, and it involves a loan or term payments, the Pitcher™ app replaces all consumer PII with the GAIN™, which serves as the sole identifier for future payment interactions. This ensures that merchants or platforms maintain transaction records and processes using the GAIN™ without storing any PII.

Merchant/Platform/Waterfall Sends Payment Requests Through Catcher App/API for Loan/Time Payments from Consumer Using GAIN™: In cases where time-based payments or loans are involved, the merchant/platform sends payment requests through the Catcher™ app using the GAIN™. This request is routed via the quantum computing lattice system to the consumer's Pitcher™ app, where it is associated with the relevant accounts on the consumer's device. Once the consumer authorizes the payment, funds are transferred to the merchant via the GAIN™ identifier, ensuring no PII is exchanged in the process.

All Systems for Payment Confirmation Remain the Same—Only the Identifier is Different: All existing payment processing systems and confirmation protocols on the merchant/platform/waterfall side remain unchanged. The only variation is that, instead of relying on PII for payment confirmation and identification, the merchant uses the GAIN™. The GAIN™ serves as the consumer's anonymous identifier for payment tracking and processing, ensuring full privacy protection for the consumer.

Dynamic Interface Adjustments and Optimization: The interface between the Pitcher™ and Catcher™ apps is dynamically adjustable, allowing for optimization based on merchant needs, user preferences, and past transaction data. This includes the ability to modify interface layouts, forms, and other transaction elements using machine learning techniques. Importantly, these optimizations occur only through data associated with the GAIN™, ensuring that no PII is accessed or used during the adjustments. These features ensure smooth transaction processing while protecting the consumer's identity.

Collection of Generic Consumer Data Without PII: Merchants, platforms, and other entities can continue to gather valuable transactional and marketing data from consumers without the need to access or store PII. This aggregated, non-identifiable data provides businesses with insights into purchasing behavior while safeguarding consumer privacy.

Data Collection in Medical and Insurance Fields: In the medical and insurance sectors, the Pitcher™ and Catcher™ apps allow for the secure collection and analysis of product or service usage data without violating privacy regulations like HIPAA or HITECH. Through the use of the GAIN™, these industries can benefit from detailed analytics without the need to handle sensitive personal data.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for securing personally identifiable information (PII) during monetary transactions, comprising:
receiving, by a first application (Pitcher) installed on a user device, personal information for transaction purposes;
generating a Generative Artificial Intelligence Number (GAIN) associated with the user;
transmitting the GAIN to a second application (The Catcher) operated by a merchant; and
facilitating the completion of a transaction between the user and the merchant using the GAIN without transmitting or retaining PII.

2. The method of claim 1, wherein the GAIN is generated based on a user-specific AI-driven analysis conducted on the user's device.

3. The method of claim 1, further comprising the steps of:
verifying the user's identity based on device-specific data; and
storing the PII locally on the user's device without sharing it with external systems.

4. The method of claim 1, wherein the second application (The Catcher) is configured to delete all transaction-related PII upon completion of the transaction.

5. A system for secure transactions, comprising:
a first application (Pitcher) installed on a user's device for storing and managing PII locally and generating a GAIN for transactions; and
a second application (The Catcher) installed on a merchant system for processing transactions using the GAIN without accessing or retaining the user's PII.

6. The system of claim 5, wherein the GAIN is encrypted using quantum encryption methods to ensure secure and private transactions.

7. A method for conducting secure transactions using a generative artificial intelligence system, comprising:
establishing a permanent, encrypted pathway for a user within a quantum computing lattice platform;
assigning a unique Generative Artificial Intelligence Number (GAIN) to the user as an identifier for transactions;
initiating a transaction at a merchant, platform, or waterfall system via a first application (Pitcher) installed on the user's device;
interfacing, via an API, the first application (Pitcher) with a second application (Catcher) installed on the merchant's platform;
transmitting necessary financial information from the first application to the second application to complete the transaction;
removing all PII from the transaction once the purchase, loan, or payment is approved or denied; and
replacing PII with the GAIN for any approved loan or payment transactions.

8. The method of claim 7, wherein the GAIN is used to facilitate term payments or loans, such that future payment requests from the merchant/platform are processed using the GAIN without the need for PII.

9. The method of claim 7, wherein upon a declined transaction, all PII is removed without retaining the GAIN, ensuring no personal data or identifiers are stored by the merchant.

10. The method of claim 7, wherein payment confirmation systems for merchants and platforms remain unchanged, and the only identifier used is the GAIN.

11. A system for processing secure transactions without storing personally identifiable information (PII), comprising:
a first application (Pitcher) installed on a user's device, configured to transmit financial information using a GAIN;
a second application (Catcher) installed on a merchant's platform, configured to receive transaction requests via the GAIN; and
a quantum computing lattice platform for routing payment requests and confirmations using the GAIN without accessing or storing PII.

12. The system of claim 11, wherein the user's PII is stored locally on their device and replaced with the GAIN for any transaction interactions with the merchant.

13. The system of claim 11, further comprising dynamic adjustment capabilities for the interface between the first and second applications based on transaction-specific data gathered via the GAIN, with no PII used for interface modifications.
